(19) United States
(12) Patent Application Publication
(10) Pub. No.: US 2007/0015459 A1
(43) Pub. Date: Jan. 18, 2007

(54) Relaying radio communication between a base station and a mobile terminal using a control channel at a longer time interval

(75) Inventor: Hiroki Okazaki, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/481,949

(22) Filed: Jul. 7, 2006

(30) Foreign Application Priority Data
Jul. 15, 2005 (JP) 2005-206994

(51) Int. Cl. H04B 7/15

(52) U.S. Cl. 455/11.1

(57) ABSTRACT

A repeater terminal usually functions as a mobile terminal served by a base station for radio communication. The repeater terminal receives a control channel at a time interval from the base station. The repeater terminal, when operating as a relaying station for another mobile terminal, sends out the control channel thus received to the other mobile terminal at a time interval longer than the interval at which it receives the control channel from the base station. The mobile terminal carries out intermittent reception at the longer time interval in timed with the control channel sent out from the repeater terminal, thereby reducing its electric power consumption.

### BACKGROUND OF THE INVENTION

1. Field of the Invention

The present invention relates to a method and an apparatus for relaying radio communication between a base station and a mobile communication terminal device. More particularly, the present invention relates to a communication method and an apparatus for relaying a control channel transmitted from a base station.

2. Description of the Background Art

Heretofore, mobile communication terminals of, for example, the PHS system(Personal Handyphone System), are timed with a control channel, transmitted from a base station at a time interval of 100 msec, to receive a call at a time interval of, for example, 1.2 sec, in order to accept a call, thus carrying out intermittent call reception control. By the intermittent reception control, the mobile communication terminals are able to limit the call reception time to suppress the electric power consumption thereof.

There are provided a plural number of timings at which a mobile communication terminal receives information transmitted from a base station. At one of those timings which allows a mobile communication terminal to accept an incoming call, the mobile communication terminal will receive a call.

The afore mentioned intermittent reception is described in for example Japanese patent laid-open publication No. 141365/1994. This laid-open publication discloses that the mobile station variably sets an intermittent reception period of time among the timings of receiving signals from a base station so as to reduce the rate, or increase the intervals, of the intermittent reception.

With the conventional call waiting operation, in order to accept an incoming call to be ready for reception, mobile communication terminals carry out intermittent reception in synchronous with a base station at timings where the respective mobile communication terminals define. Hence, there is presented a problem that the mobile terminals quantitatively consume the electric power by themselves.

### SUMMARY OF THE INVENTION

It is an object of the present invention to provide a method and an apparatus for relaying radio communication between a base station and a mobile communication terminal device, in which the problem of quantitative power consumption may be minimized.

In accordance with the present invention, a method for relaying radio communication between a base station and a mobile communication terminal device located within a service area of the base station by carrying out a relaying function transmitting a control channel transmitted from the base station to the mobile communication terminal device comprises the steps of receiving a control channel at a first transmitting interval transmitted from the base station, and transmitting the control channel to the mobile communication terminal device at a second transmitting time interval which is set longer than the first transmitting time interval.

According to the present invention, there is also provided a relaying apparatus for carrying out a relaying function of transmitting a control channel transmitted from a base station to a mobile communication terminal device, in which a control channel transmitted from the base station at a first transmitting time interval, and the control channel is transmitted to the mobile communication terminal device, located in a service area of the base station, at a second transmitting time interval which is set longer than the first transmitting time interval.

According to the present invention, the mobile communication terminal device has its relaying function exploited to variably control the period of intermittent reception so as to be longer during its standby time, such as call waiting time. This reduces the power consumption of the mobile communication terminal device operating as a usual mobile terminal served by the base station. Since the mobile communication terminal device thus exploits its relaying while being in its standby mode, it may be used efficiently without modifying the configuration of the base station.

### BRIEF DESCRIPTION OF THE DRAWINGS

The objects and features of the present invention will become more apparent from consideration of the following detailed description taken in conjunction with the accompanying drawings in which:

FIG. 1 is a schematic view showing the configuration of a mobile communication system in accordance with an embodiment of the present invention;

FIG. 2 is a timing chart useful for understanding the operation of the embodiment of the mobile communication system including a repeater terminal in accordance with the present invention;

FIG. 3 is a timing chart useful for understanding the operation of direct communication between a base station and a mobile terminal;

FIG. 4 is a flowchart useful for understanding the operation during the call waiting period of the repeater terminal;

FIG. 5 is a flowchart useful for understanding the call waiting control of the mobile terminal; and

FIG. 6 is a flowchart useful for understanding the call waiting operation of the repeater terminal.

### DESCRIPTION OF THE PREFERRED EMBODIMENTS

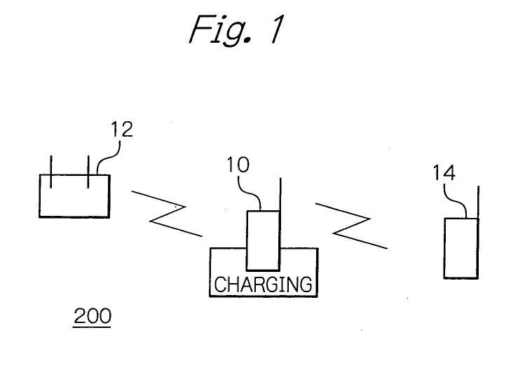

With reference to the accompanying drawings, a preferred embodiment of a radio communication system according to the present invention will be described in detail. Referring first to FIG. 1, there is schematically shown an illustrative structure of a wireless telecommunications system 200, inclusive of a repeater terminal 10, serving as a mobile communication terminal device embodying the present invention. The repeater terminal 10 is a mobile terminal device operating as a repeater between a base station 12 and a mobile terminal 14. In the present embodiment, the repeater terminal 10 and the mobile terminal 14 are compatible with a digital cordless communication system, such as PHS system (Personal Handyphone System). The base station 12 performs bidirectional communication with the repeater terminal 10 and the mobile terminal 14, under the digital cordless communication system, in order to establish connection paths with the mobile terminals, other base stations and other communication networks. FIG. 1 shows a limited number of station and terminals. In practice, however, the wireless telecommunications system 200 may includes a lot of base stations and a lot of mobile terminals, which are not included in the figure merely for the purpose of simplicity.

The repeater terminal 10 has the same functions as the mobile terminal 14 to operate as a mobile terminal in its normal operating mode. In addition, the repeater terminal 10 may take its standby state in its call waiting time or mode, which the terminal 10 is rendered during charging its battery, not shown, for example. In an application in which the repeater terminal 10 is allowed for the repeater function, for example, during its standby period of time, the repeater terminal 10 executes the repeater function of acting as a relay station between the base station 12 and the mobile terminal 14. The repeater function may be executed not only during the battery charging but also when the function is allowed by, for example, manual operating on the repeater terminal.

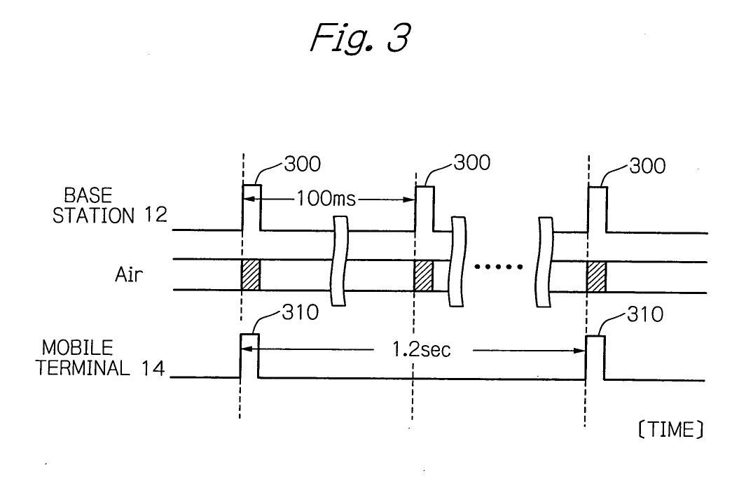

As shown in FIG. 3, when the base station 12 and the mobile terminal 14 directly communicate with each other, without the intermediary of the repeater terminal 10, the mobile terminal 14 executes intermittent reception, at a time interval of 1.2 sec with the illustrative embodiment, in timed with a control channel 300, transmitted from the base station 12 at a time interval of 100 msec.

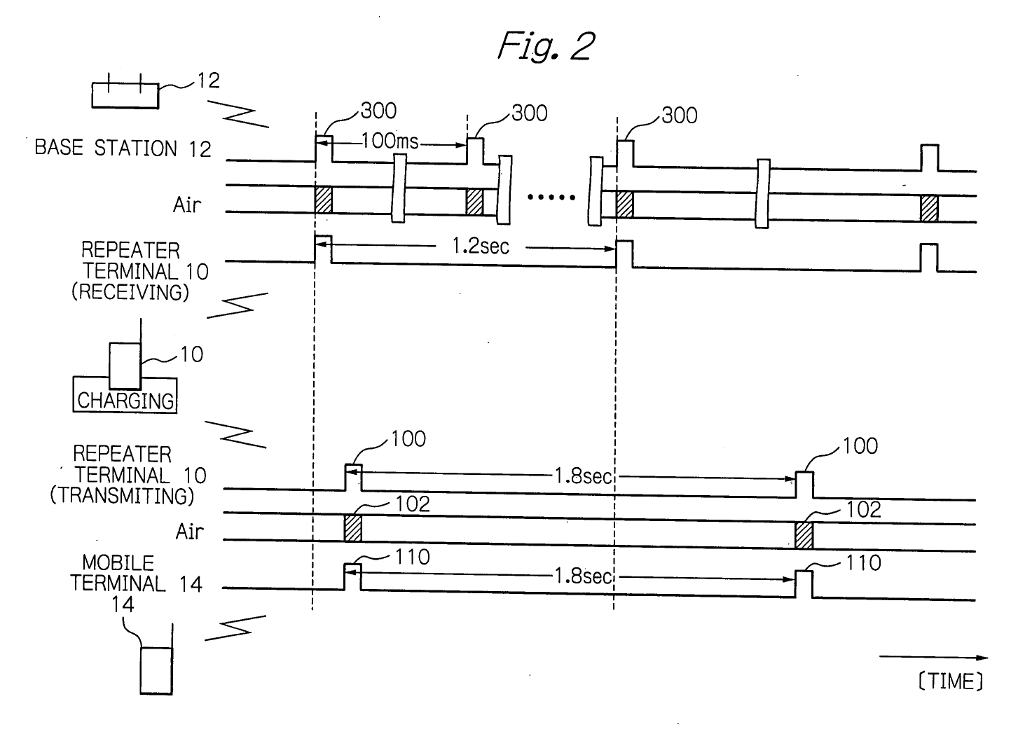

If the repeater terminal 10 executes its repeater function to act as a relay station for the mobile terminal 14, the repeater terminal 10 sends out control channels 100, FIG. 2, toward the mobile terminal 14. The repeater terminal 10 intermittently sends out control channels 100 at a time interval longer than that of the control channel transmitted from the base station 12. Specifically with the instant embodiment, the repeater terminal 10 sends out control channels 100 at a time interval of, for example, 1.8 sec, which is set longer than 1.2 sec, through its relaying function during the call waiting mode, as exemplified in FIG. 2. The timing for transmitting control channels 100 from the repeater terminal 10 is not limited to 1.8 sec, but may be set longer, such as 1.6 sec or 2.0 sec, than the time interval of 1.2 sec of the control channel 300, transmitted from the base station 12.

The mobile terminal 14 has the function of being, when exploiting the repeater terminal 10 as a relay station therefor, responsive to information 102 carried on the control channel 100 transmitted from the repeater terminal 10 to be timed with the control channel 100, thereby carrying out intermittent reception at a time interval of 1.8 sec with the embodiment.

By the above configuration, the repeater terminal 10 operates as a relay station, during the call waiting time, such as during battery charging, thus substantially expanding the communication area served by the base station 12. Further, the repeater terminal 10 normally accomplishes its communication function as an ordinary mobile terminal even in its call waiting mode, such as during battery charging, to allow its communication function to be efficaciously utilized. Moreover, when the mobile terminal 14 is connected to the repeater terminal 10, operating as a relay station, the mobile terminal 14 may carry out intermittent reception, at a receiving timing interval which is set longer than when the mobile terminal is connected to the base station 12. Thus, the reception timing is controlled to a time interval longer than the intermittent period exceeding one allowed for the base station 12. Hence, electric power consumed by the mobile terminal 14 may be decreased accordingly.

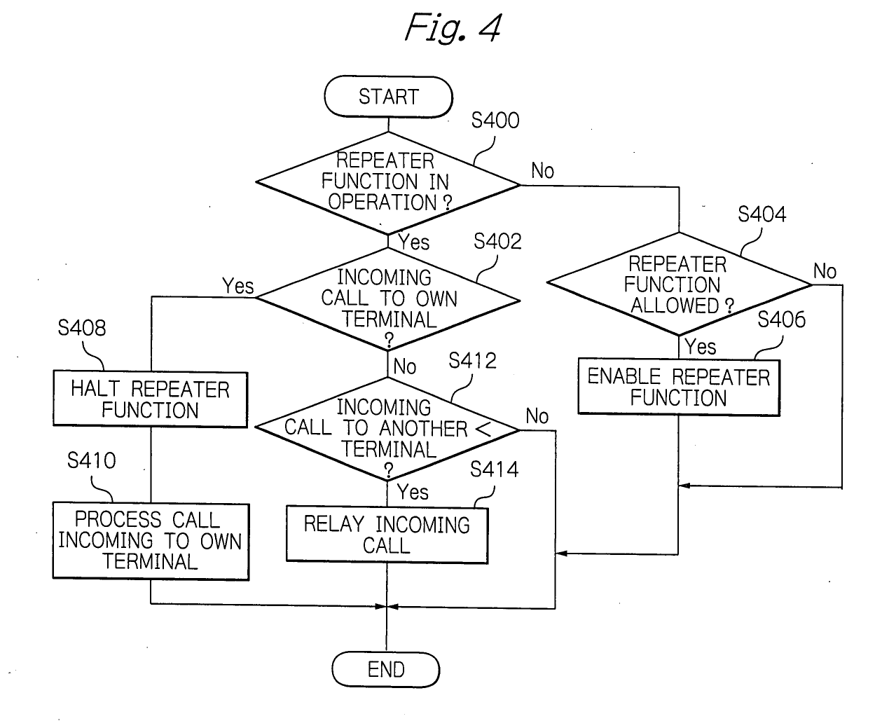

In the above configuration, the operation of the communication system 200, inclusive of the repeater terminal 10 and the mobile terminal 14, will now be described with further reference to FIGS. 4, 5 and 6. Referring first to FIG. 4, in a step S400, the repeater terminal 10, while in its call waiting operation, verifies whether or not its repeater function is currently effective. If the repeater function is in operation, then processing transfers to a step S402. If the repeater function is not in operation, processing transfers to a step S404. In this step S404, it is verified whether or not the repeater function is allowed. If a user has allowed the repeater function, as when the user has commenced charging the battery, the control transfers to a step S406, in which the repeater function comes in operation.

In the step S402, it is verified whether or not there is any incoming call to the own terminal, i.e. repeater terminal 10. If there occurs any incoming call, processing transfers to a step S408 to halt the repeater function. Then, processing transfers to a step S410 where the processing for the incoming call is carried out.

If no incoming call to the own terminal 10 has been detected in the step S402, processing transfers to a step S412. In this step S412, it is detected whether or not there is any incoming call to another mobile terminal, such as terminal 14, staying in the service area established by the repeater terminal 10 but not necessarily covered by the base station 12. If there comes a call meant for the other terminal 14, processing transfers to a step S414. In this step, the call incoming to the other terminal 14 is relayed by the repeater terminal 10 to that terminal 14.

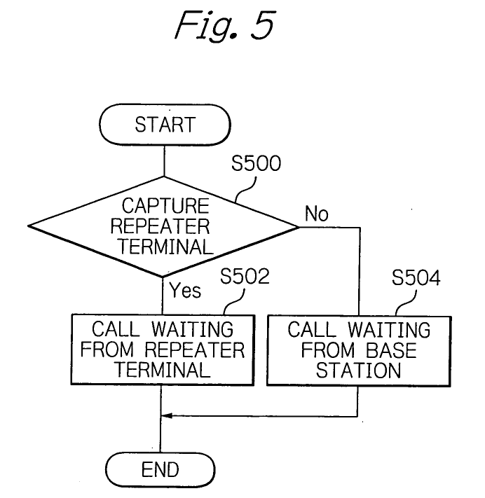

The call waiting operation in the mobile terminal 14 will proceed as shown in FIG. 5. In a step S500, it is verified whether or not the mobile terminal 14 has captured the repeater terminal 10, more specifically whether or not the mobile terminal 14 has recognized the control channels 100 transmitted by the repeater terminal 10. If the mobile terminal has captured the repeater terminal 10, then processing transfers to a step S502. In the step 502, the mobile terminal 14 searches for a repeater terminal which uses one of the eight channel positions for detecting an incoming call which is the same as the control channel position for detecting an incoming call allotted to the own mobile terminal 14 to thereby capture that repeater terminal, i.e. the repeater terminal 10 in this example. The mobile terminal 14 then proceeds to the processing of waiting for a call incoming from the repeater terminal 10 thus captured. The mobile terminal 14 then acquires reception control information transmitted from the repeater terminal 10 to thereby proceed to the call waiting operation at a time interval carried on the information and defined by the repeater terminal 10. In the step S500, if it is determined that the mobile terminal 14 has not captured the repeater terminal 10, processing transfers to another step S504 to proceed to the usual call waiting operation for the base station 12.

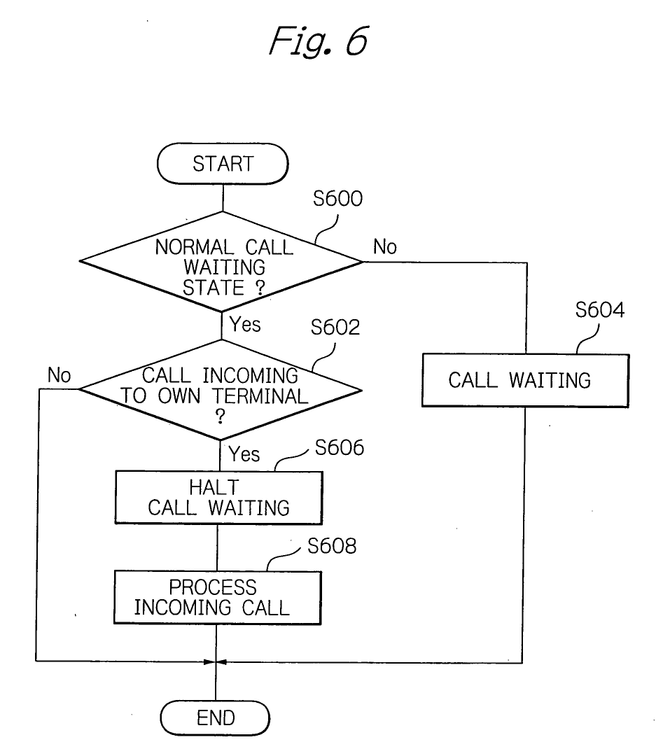

The processing for incoming call waiting in the step S502 will now be described in more detail. Referring to FIG. 6, it is verified, in a step S600, on the side of the mobile terminal 14, whether or not the call waiting operation in the step S600 is being carried out as normally. If the call waiting operation is being carried out normally, processing transfers to a step S602. In the latter step, it is verified whether or not a call incoming to the own terminal 14 has arrived. If there is such an incoming call detected, then the call waiting operation is halted to proceed to the step S608, where the incoming call will be processed. In this case, the mobile terminal 14, which has detected the incoming call relayed or transferred by the repeater terminal 10, re-captures the base station 12 to allow speech or communication processing to commence between the mobile terminal 14 and the base station 12.

In the step S600, if it is determined that the call waiting operation is not being executed normally, then processing transfers to a step S604 where the mobile terminal 14 proceeds to the call waiting control shown for example in FIG. 5. Thus, the mobile terminal 14 executes the call waiting operation to wait for a call from the base station 12 or the repeater terminal 10.

As described above, the call waiting operation is timed with a time interval set for the repeater terminal 10 to thereby wait for a call arrived from the repeater terminal 10, so that the time interval may be set longer than conventional. That causes less electric power to be consumed by the mobile terminal 14, even without modifying the configuration of the base station 12. Moreover, such reduction in power consumption may be attained during for example the call waiting time of the repeater terminal 10, when functioning as a usual mobile terminal and having its battery charged, for example. Specifically, the relaying operation is performed during the call waiting time of the repeater terminal 10, which also functions as a usual mobile terminal such as terminal 14, hence efficaciously utilizing its mobile communication function.

The entire disclosure of Japanese patent application No. 2005-206994 filed on Jul. 15, 2005, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A method for relaying radio communication between abase station and a mobile communication terminal device located within a service area of the base station by carrying out a relaying function transmitting a control channel transmitted from the base station to the mobile communication terminal device, comprising the steps of:
receiving a control channel at a first transmitting interval transmitted from the base station; and
transmitting the control channel to the mobile communication terminal device at a second transmitting time interval, the second transmitting time interval being set longer than the first transmitting time interval.

2. The method in accordance with claim 1, wherein said relaying function is carried out during standby time of the mobile communication terminal device.

3. The method in accordance with claim 2, wherein said relaying function is carried out when the mobile communication terminal device has a battery charged.

4. A relaying apparatus for carrying out a relaying function of transmitting a control channel transmitted from a base station to a mobile communication terminal device, wherein
a control channel transmitted from the base station is received at a first transmitting time interval, and
the control channel is transmitted to the mobile communication terminal device located in a service area of the base station at a second transmitting time interval, the second transmitting time interval being set longer than the first transmitting time interval.

5. The apparatus in accordance with claim 4, wherein said relaying function is carried out during standby time of the mobile communication terminal device.

6. The apparatus in accordance with claim 5, wherein said relaying function is carried out when the mobile communication terminal device has a battery charged.

7. A mobile communication terminal device for communicating on radio with a base station, wherein
said device includes a- relaying function of transmitting a control channel transmitted from the base station to another mobile communication terminal device located in a service area of the base station,
a control channel transmitted from the base station is received at a first transmitting time interval, and
the control channel is transmitted to the other mobile communication terminal device at a second transmitting time interval, the second transmitting time interval being set longer than the first transmitting time interval.

8. The device in accordance with claim 7, wherein said relaying function is carried out during standby time of said device.

9. The device in accordance with claim 8, wherein said relaying function is carried out when said device has a battery charged.
